(19) United States
(12) Patent Application Publication
(10) Pub. No.: US 2025/0146233 A1
(43) Pub. Date: May 8, 2025

(54) METHOD AND DEVICE FOR DIFFERENTIAL HEIGHT MODIFICATION OF THE SURFACE OF THE TRAFFIC AREA

(71) Applicant: Exact Control System a.s., Praha 6 (CZ)

(72) Inventors: Vitezslav OBR, Trebic (CZ); Marek PRIKRYL, Velka Chuchle (CZ)

(21) Appl. No.: 18/832,812

(22) PCT Filed: Jan. 24, 2023
(86) PCT No.: PCT/CZ2023/000003

§ 371 Date: Jul. 24, 2024

(30) Foreign Application Priority Data
Feb. 9, 2022 (CZ) PV 2022-63

(51) Int. Cl. E01C 19/00; E01C 19/48; E01C 23/088

(52) U.S. Cl. CPC E01C 19/004; E01C 19/48; E01C 23/088

(57) ABSTRACT

The method of differential height modification of the surface of the traffic area, in which the surface of the traffic area before modification is measured and a digital model of the surface of the traffic area before modification is calculated. The design of the target surface of traffic area after modification is determined. The differential model of the height adjustments is calculated from the differences in the heights of these surfaces. During modification, the X, Y position of the right and left working part of the working tool of the construction machine is then determined, which creates a new surface by modifying, and the appropriate target height adjustment Ft (X, Y) from the unmodified surface of the traffic area is determined from the differential model of the height adjustments. This information is transmitted to the control computer of the construction machine, which makes the necessary adjustments to the construction machine to achieve the desired height and cross slope of the modification. To determine the X, Y position of the right and left working part of the working tool, data from a total station arranged stationary outside the construction machine is used and then the height of the adjustments Ft (X, Y) is determined from the differential model of the height adjustments. A device for carrying out such a method is further described.

### TECHNICAL FIELD

The invention relates to a method of differential height adjustment of the surface of the traffic area, in which the surface of the traffic area before adjustment is measured and a digital model of the surface of the traffic area before adjustment is calculated, the design of the target surface of the traffic area after adjustment is determined, a differential height adjustment model is calculated from the height differences of these surfaces, during adjustment, the X, Y position of the right and left working parts of the working tool of the construction machine, which creates a new surface by modifying, or the X,Y position of the unmodified surface of the areas adjacent to the right and left working parts of the working tool, is determined and the appropriate target height adjustment Ft (X,Y) is determined from the differential model of the height adjustments from the unmodified surface of the traffic area, this information is transmitted to the control computer of the construction machine, which makes the necessary settings of the construction machine to achieve the required height of the modification and the cross slope of the modification. The invention further relates to a device for performing such a method.

### BACKGROUND ART

Repairing the surface of traffic areas, such as asphalt roads, requires first removing a certain thickness of the damaged top layer and paving a new layer.

The aim of the milling process is to achieve optimum longitudinal flatness and such cross slopes to ensure sufficient drainage. A new structural layer of ideally constant thickness is then paved on such a surface at each point of the area to be repaired. It is not advisable to compensate for the uneven surface after milling by paving, as the different thicknesses of material paved have different compressibility and the original unevenness will soon be copied onto the new surface after repair.

Optimum longitudinal flatness and cross slopes are achieved by various methods. The most modern are the so-called 3D milling methods. These methods provide the road milling machine with information about the depth and cross slope of the milling depending on its position.

Two basic principles of these 3D milling methods are known.

The first is the principle of absolute guidance of the road milling machine, so called profile milling, where the total station (e.g. Trimble 3D milling), which is a surveying device for measuring and registering the measured values of horizontal angles, elevation angles, distances and their conversion to rectangular coordinates, or a combination of a GNSS receiver and a laser levelling device, absolute X, Y, Z coordinates of the milling machine are determined in a coordinate system independent of the road milling machine (for example, in the UTM coordinate system with ellipsoidal heights) in which the target design of the surface of the traffic area after milling is projected. Based on the difference between the height of the road milling machine, namely the milling drum, and the height of the target designed surface after milling at the X, Y location of the road milling machine, the absolute height of the milling drum is set. (e.g. Topcon 3D mmGPS or Trimble 3D milling)

The second is the principle of differential milling, where the surface of the traffic area before milling is first measured in 3D, the design of the target surface after milling is projected, and from the differences in the heights of these surfaces, a so-called differential model of milling depths or generally called a differential model of height adjustments is calculated, which defines the target depth of the milling from the surface of the unmilled surface for each location X,Y of the traffic area. During milling, only the X,Y position of the road milling machine is determined, specifically the locations of the lower right and left sides of the milling drum or the X,Y position of the unmilled surface of the areas adjacent to the lower right and left sides of the milling drum, and the appropriate target milling depth Ft (X,Y) is determined from the differential model. This information is passed to the control computer of the road milling machine, which will make the necessary adjustments of the road milling machine to achieve the desired target milling depth from the unmilled surface and the desired cross slope of the target surface after milling. Such a procedure is described, for example, in patent U.S. Pat. No. 8,961,065B2.

Each of these two methods has its pros and cons.

The main advantage of differential milling is that only the horizontal X, Y position of the road milling machine needs to be specified for precise milling, with centimeter accuracy. For this you only need to use a GNSS receiver.

On the contrary, the principle of absolute guidance of the road milling machine requires precise millimeter determination of the height Z of the road milling machine, for which either a total station or a laser leveling device must be used. The latter must have direct visibility to the aiming target on the road milling machine, for example a reflecting prism, which is often not possible due to traffic on the milled road or vegetation around the milled road. At the same time, the distance between the road milling machine and the total station or leveling laser device should not be longer than 100 m due to the exponential decrease in height determination accuracy. For these reasons, it is necessary to have three or even more of these instruments and to move them along the milling trajectory during milling, which requires significant demands on the skilled operation of the measuring instruments and the road milling machine and the planning of the milling procedure. The total station must be accurately levelled and its X, Y, Z spatial position and orientation determined before measurement begins. This is done, for example, by measuring at least two surrounding points with known spatial coordinates X, Y, Z. The position and orientation of the total station is then calculated from this measurement. This again places high demands on qualified operators of the measuring instruments.

The disadvantage of the differential method (for example, described in U.S. Pat. No. 8,961,065B2) is that it cannot use GNSS receivers to determine the position in places with a limited signal, such as dense urban development, so-called urban canyons or tunnels,

The aim of the solution according to the invention is to propose a solution that would eliminate the disadvantages of the state of the art.

### SUMMARY OF THE INVENTION

The stated goal is achieved by means of differential height modification of the surface of the traffic area, in which the surface of the traffic area before modification is measured and a digital model of the surface of the traffic area before modification is calculated, the design of the target surface of the traffic area after modification is determined, and the differential model of height adjustments is calculated from the differences in the heights of these surfaces, during modification, the X, Y position of the right and left working parts of the working tool of the construction machine, which creates a new surface by modifying, or the X,Y position of the unmodified surface of the areas adjacent to the right and left working parts of the working tool, is determined, and the corresponding target height of the adjustment Ft (X,Y) from the unmodified surface of the traffic area is determined using the differential model of the height adjustments, this information is transmitted to the control computer of the construction machine, which makes the necessary adjustments of the construction machine to achieve the desired height of modification and cross slope of the modification, according to the invention, the essence of which is that to determine the position X, Y are used data from a total station, arranged stationary outside the construction machine and then the height of the adjustments Ft (X, Y) is determined using the differential model of the height adjustments.

The advantage of the method of differential height modification of the surface of the traffic area according to the invention is that it is fully functional even in places where the GNSS signal is of poor quality, or where it is not available at all.

Another advantage is that the distance between the construction machine and the total station can be several times longer than with the absolute guidance of the construction machine, because only the horizontal position X, Y is determined by the total station. The requirements for the accuracy of determining the horizontal position of the construction machine X, Y are several times lower. It is enough to achieve accuracy in the range of centimetres compared to the requirements for determining the vertical position of the construction machine Z, which must be within a few millimetres. At the same time, the determination of the horizontal X,Y position of the construction machine using a total station is more accurate due to physical limits (for example, refraction), which primarily reduce the accuracy of determining the vertical Z position.

According to an advantageous embodiment, data from the GNSS receiver arranged on the construction machine is additionally used to determine the X, Y position of the right and left working part of the working tool of the construction machine, or the X,Y position of the unmodified surface of the areas adjacent to the right and left working parts of the working tool, while using the X, Y coordinates from the GNSS receiver to automatically determine the orientation and position of the total station.

The advantage of this advantageous embodiment of the method according to the invention, which additionally uses data from the GNSS receiver, is that the GNSS coordinates X, Y are used to automatically determine the orientation and position of the total station. This will reduce the requirement for the professional qualification of the operator of the total station. It is enough for the total station to be aimed at the reflecting prism on the construction machine, which is preferably located in the vertical axis of the GNSS antenna, and let it be tracked automatically (so-called tracking). If the construction machine is in motion, the position and orientation of the total station will be determined within a few seconds or minutes using the commonly known method of calculating the so-called free station. It is a prerequisite that the total station, or a central computer connected to the total station, receives on-line information about the position of the GNSS antenna, e.g. via a radio link, and that a high-quality GNSS signal is available at the time of measurement (e.g. before entering the tunnel). In the same way, the position and orientation of the total station can be refined or verified during surface preparation or, conversely, the accuracy of the GNSS placed on the construction machine can be checked.

According to another advantageous embodiment, together with the information about the height adjustment on the right and left side of the working part of the working tool from the unmodified surface of the traffic area, the information about the target cross slope of the working tool is also sent to the control computer of the construction machine, which is calculated from the design of the target surface after modification, or from a combination of a digital model of the surface of the traffic area before modification and a differential model of height adjustments.

The advantage of this advantageous embodiment of the method according to the invention is that it enables the surface to be modified even in a place where one side of the working tool does not have data on the height of the adjustment, for example due to the fact that this part of the working tool is outside of the traffic area being modified. Such a situation occurs, for example, when modifying the surface at the roadside. In such a situation, the available information about the height adjustment for the side of the work tool that is above the traffic area and the cross slope of the adjustment is used to set the adjustment heights and cross slopes of the work tool.

The stated goal is also achieved by a device for carrying out such a method, including a construction machine with a working tool, while the construction machine is provided with a control computer of the construction machine, adapted to adjust the cross slope and height of the work tool, and the control computer of the construction machine is connected to a central computer, equipped with a central data storage, according to the invention, the essence of which is that at least one reflecting prism is placed on the construction machine for at least one total station, arranged immovably outside the construction machine.

According to an advantageous embodiment, at least one GNSS receiver is placed on the construction machine, while the reflecting prism is arranged in the vertical axis of the GNSS receiver antenna with a known vertical offset from the phase center of the GNSS receiver antenna or in a location outside the vertical axis of the GNSS receiver antenna, where this location has a known longitudinal, transverse and height offset from the phase center of the GNSS receiver antenna.

According to another advantageous embodiment, the central computer is arranged on the construction machine and is connected to the control computer of the construction machine by means of a communication interface.

According to another advantageous embodiment, the central computer and the control computer of the construction machine are formed by one common control computer of the construction machine.

According to advantageous embodiments, the construction machine may be a road milling machine and the working tool may be a milling drum or a paver with a screed plate, wherein the height adjustment is the milling depth or the thickness of the pavement.

### BRIEF DESCRIPTION OF DRAWINGS

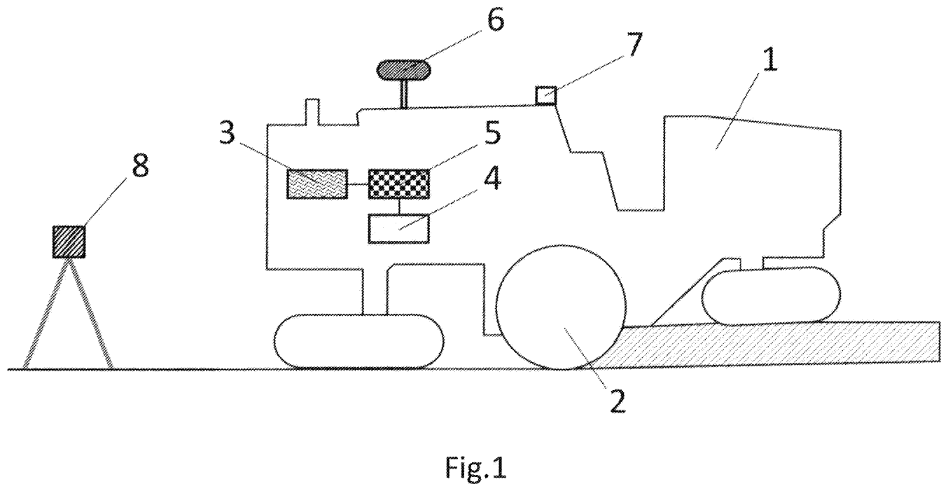

The invention will be described in more detail on the example of a specific embodiment of the device according to the invention, shown in FIG. 1.

### EXAMPLES OF EMBODIMENTS

The method of differential height modification of the surface of the traffic area will be described on the example of milling the traffic area, when the construction machine is the road milling machine 1 and the working tool is the milling drum 2. It is obvious to experts that a construction machine can also be a paver with a screed plate, or other construction machines such as road rollers, dozers or graders, not only for work on roads but also on all earthworks in transport and civil engineering.

In the described method of differential milling of the surface of the traffic area, both the total station 8, arranged immovably outside the road milling machine 1 and using the reflecting prism 7, located on the road milling machine 1, and the GNSS receiver 6 are used, while the reflecting prism 7 is arranged In the vertical axis of the antenna of the GNSS receiver 6 with known vertical offset. The reflecting prism 7 can also be located at a location outside the vertical axis of the antenna of the GNSS receiver 6, where this location has a known longitudinal, transverse and height offset from the phase center of the GNSS receiver 6.

To determine the position and orientation of the total station 8, it is also possible to use the combination of the method of measuring surrounding points with known spatial coordinates X, Y, Z and the method of measuring the reflective prism 7 on the road milling machine 1. Such a combination of measurements can be advantageously used, for example, in a place where it is not possible to measure more than one surrounding point with the total station 8 and at the same time the spatial configuration of the position of the total station 8 and the road milling machine 1 and the direction of movement of the road milling machine 1 do not allow the determination of the position and orientation of the total station 8 with sufficient accuracy only from measuring on the reflecting prism on the road milling machine. This combined measurement has a number of variations.

It is important to emphasize that the problem can also be solved only in the two-dimensional coordinate system X, Y. when only horizontal angles are measured, only the X, Y coordinates of the reflecting prism 7 on the road milling machine 1 and the surrounding points are known, and only the X, Y coordinates and orientations are calculated.

The device for carrying out the method includes a road milling machine 1 with a milling drum 2. The road milling machine 1 is equipped with a road milling machine control computer 3, modified to set the cross slope and milling depth of the milling drum 2. The road milling machine control computer 3 is connected to the central computer 5, equipped with a central data storage 4.

In the described embodiment, the central computer 5 and the central data storage 4 consist of one common outdoor computer Panasonic Toughpad FZ-G1 with an Intel 15-4310U 2.00 GHZ processor, 8GB operating memory, and the central data storage is an SSD disk with a capacity of 128 GB.

The central computer 5 is arranged directly on the road milling machine 1 and is connected to the road milling machine control computer 3 via a communication interface. In the described embodiment, the communication interface consists of the CAN-BAS protocol and a cable.

Before the actual milling, the surface of the traffic area is measured using one of the known methods and a digital model of the surface of the traffic area is calculated before milling.

At the same time, the desired design of the target surface of the area after milling is determined.

The differential model of milling depths is calculated from the differences in the heights of the measured surface of the traffic area before milling and the desired design of the target surface after milling. And this differential model of the milling depth and the design of the target surface after milling is uploaded to the central storage 4 before the milling starts.

From the differential model of milling depth, the relevant target milling depth Ft (X,Y) from the unmilled surface of the traffic area is determined, and from the design of the target surface after milling, the cross slope of the milling drum is determined, and this information is passed to the control computer 3 of the road milling machine 1, which makes the necessary adjustments of the road milling machine 1 to achieve the required depth and cross slope of the milling,

During milling, using data from the total station 8 and the GNSS receiver 6 and the longitudinal, transverse and height offsets of the reflecting prism 7 from the right and left lower sides of the milling drum 2, and longitudinal and transverse inclinations (pitch, roll) of road milling machines determines the X, Y position of the right and left lower sides of the milling drum 2, and subsequently determines the relevant target milling depth Ft (X, Y) on the right and left sides of the milling drum using the differential model of the milling depths and from the design of the target surface of the traffic area after milling, the cross slope of the milling drum 2 is determined for a given position of the milling drum 2, which is defined by the X, Y coordinates of the right and left sides of the milling drum 2.

The current longitudinal and cross slope (pitch, roll) of the road milling machine 1 can be obtained, for example, from an inclinometer that is a common part of the road milling machine 1 or from an external sensor for measuring the slope, which is located on the body or frame of the road milling machine. The actual cross slope can also be calculated, for example, from the design of the target surface of traffic area after milling, assuming that the milling process creates a new surface exactly according to this design of the target surface after milling.

The central computer 5 obtains on-line information about the X, Y position of the GNSS receiver 6 on the body of the road milling machine 1 and information about the X, Y position of the reflecting prism 7 on the body of the road milling machine 1. The GNSS receiver 6 position data is obtained by the central computer 5 directly from the GNSS receiver 6 and stored in the central data storage 4 of the central computer 5.

Data on the position of the reflecting prism 7 are obtained from the total station 8, which continuously measures the reflecting prism 7. Communication between the total station 8, the GNSS receiver 6 and the central computer 5 is provided by a wireless method, for example by a radio data link. The central computer 5 evaluates the data, determines the position and orientation of the total station 8 (using data on the position of the antenna of the GNSS receiver 6 or measured data on the position of the reflecting prism 7 using the second total station), checks the accuracy, refines the individual measurements and calculates the most likely position of the road milling machine 1. If the differential model of the milling depth and the design of the target surface of the traffic area after milling are stored in the central data storage 4, it calculates the relevant milling depth for the right and left side of the milling drum 2 and the information about the cross slope of the milling drum 2, and sends this information to the control computer 3 of the road milling machine 1, which performs the appropriate adjustment of the cross slope and milling depth of the milling drum 2. Due to the direct communication between the central computer 5 and the control computer 3 of the road milling machine, e.g. using the CAN-BUS interface, the central computer 5 and the central data storage 4 are located on the body of the road milling machine 1.

In an advantageous embodiment, two or more GNSS receivers 6 are placed on the body of the road milling machine 1, which is used to instantly determine the orientation of the road milling machine 1, control and increase accuracy.

All measurements by total station 8 and receiver 6 GNSS, the surface model of the traffic area before its milling, the design of the target surface of the traffic area after milling and the differential milling model are realized in an absolute coordinate system independent of the road milling machine 1 (for example, in the UTM coordinate system with ellipsoidal heights). Longitudinal, transverse and height offsets of the reflecting prism 7 from the right and left lower sides of the milling drum 2, are continuously recalculated during milling into an absolute coordinate system independent of the road milling machine 1 (for example, into the UTM coordinate system with ellipsoidal heights) on based on the knowledge of the orientation of the road milling machine 1, which is calculated for example from the trajectory of the movement of the road milling machine 1.

In an advantageous embodiment, two or more reflecting prisms 7 with their own identifier (e.g. Trimble active prisms) are placed on the body of the road milling machine 1. Each reflecting prism 7 can be measured (so-called tracked) by one or more total stations 8, which is again used to obtain the immediate orientation of the road milling machine 1, check and increase the accuracy of determining the X, Y position.

If a part of the milling drum 2 is outside the area of the milled traffic area, for example when milling a road shoulder, where one side of the milling drum 2 does not have milling depth data, or if the automatic algorithm or the operator of the road milling machine 1 decides that the milling depth information on one side of the milling drum 2 will not be used to set the milling depth for another reason, the information about the milling depth on the other side of the milling drum 2 and the information about the target cross slope of the milling drum 2, which is calculated from the design of the target surface, is used by the control computer 3 of the road milling machine for the correct setting of the milling drum 2, or from a combination of a digital model of the surface of the traffic area before milling and a digital differential model of the milling depth.

### LIST OF REFERENCE SIGNS

1 Road milling machine
2 Milling drum
3 Control computer
4 Central data storage
5 Central computer
6 GNSS receiver
7 Reflecting prism
8 Ttotal station

1. A method of differential height adjustment of the surface of the traffic area, in which the surface of the traffic area before adjustment is measured and a digital model of the surface of the traffic area before adjustment is calculated, the design of the target surface of the traffic area after adjustment is determined, a differential height adjustment model is calculated from the height differences of these surfaces, during adjustment, the X, Y position of the right and left working parts of the working tool of the construction machine, which creates a new surface by modifying, or the X, Y position of the unmodified surface of the areas adjacent to the right and left working parts of the working tool, is determined and the appropriate target height adjustment Ft (X,Y) is determined from the differential model of the height adjustments from the unmodified surface of the traffic area, this information is transmitted to the control computer of the construction machine, which makes the necessary settings of the construction machine to achieve the required height of the modification and the cross slope of the modification, and data from a total station, arranged stationary outside the construction machine, is used to determine the X, Y position, and then the height of the adjustments Ft (X, Y) is determined from the differential model of the height adjustments, characterized in that data from a GNSS receiver arranged on the construction machine is additionally used to determine the X, Y position of the right and left working parts of the working tool of the construction machine, or the X,Y position of the unmodified surface of the areas adjacent to the right and left working parts of the working tool, wherein the X, Y coordinates from the GNSS receiver are used to automatically determine the orientation and position of the total station.

2. (canceled)

3. The method according to claim 1, characterized in that together with the information about the height adjustments on the right and left side of the working part of the working tool from the unmodified surface of the traffic area, information about the target cross slope of the working tool is also sent to the control computer of the construction machine, which is calculated from the design of the target surface after modification, or from a combination of the digital model of the surface of the traffic area before modification and the digital differential model of the height adjustments.

4. The device for carrying out the method according to claim 1, including a construction machine with a working tool, wherein the construction machine is provided with a control computer of the construction machine, adapted to adjust the cross slope and height of the work tool, and the control computer of the construction machine is connected to a central computer equipped with a central data storage, characterized in that at least one reflecting prism (7) is placed on the construction machine for at least one total station (8), arranged immovably outside the construction machine.

5. The device according to claim 4, characterized in that at least one GNSS receiver (6) is placed on the construction machine, while the reflecting prism (7) is arranged in the vertical axis of the GNSS receiver (6) antenna with a known vertical offset from the phase center of the receiver antenna (6) GNSS or at a location outside the vertical axis of the receiver antenna (6) GNSS, where this location has a known longitudinal, transverse and height offset from the phase center of the receiver antenna (6) GNSS.

6. The device according to claim 4, characterized in that the central computer (5) is arranged on the construction machine and is connected to the control computer (3) of the construction machine via a communication interface.

7. The device according to claim 4, characterized in that the central computer (5) and the control computer (3) of the construction machine are formed by one common control computer of the construction machine.

8. The device according to claim 4, characterized in that the construction machine is a road milling machine (1), the working tool is a milling drum (2) and the height adjustment is the milling depth.

9. The device according to claim 4, characterized in that the construction machine is a road paver, the working tool is a screed plate and the height adjustment is the thickness of the paving.
